(19) United States
(12) Patent Application Publication
(10) Pub. No.: US 2020/0167463 A1
(43) Pub. Date: May 28, 2020

(54) Out-of-Band Content Analysis

(71) Applicant: HEWLETT PACKARD ENTERPRISE DEVELOPMENT LP, Houston, TX (US)

(72) Inventors: Aland Adams, Fort Collins, CO (US); Bruce A. Lundeby, Fort Collins, CO (US)

(21) Appl. No.: 16/200,565

(22) Filed: Nov. 26, 2018

(51) Int. Cl. G06F 21/55; G06F 21/57; G06F 21/71; G06F 21/81; G06F 1/3206

(52) U.S. Cl. CPC G06F 21/552; G06F 21/57; G06F 1/3206; G06F 21/81; G06F 21/71

(57) ABSTRACT

A method of validating content out-of-band for a computing device having a processor capable of executing software with a management controller separate from the processor of the computing device. The method includes identifying a content to be deployed. The content resides on a storage medium. The method further includes measuring the content and establishing a content baseline for the content based on the measuring. Also, the method includes copying a deployed content to a storage product to produce a copied deployed content. The copied deployed content is compared with the content baseline out-of-band while the deployed content is deployed. A difference is identified between the copied deployed content and the content baseline.

### BACKGROUND

Computing systems, such as servers, run various operating systems and applications within their operating environment. Security applications are run on the computing systems to protect the computing environment from malicious software and other security risks. Workload on the computing systems as a result of running security applications may influence the performance of the systems. Additionally, repairing operating systems and applications that are affected by security threats further decreases system performance, as the systems may run remediation tools or otherwise take the systems out of operation until corrective action may be taken.

### BRIEF DESCRIPTION OF THE DRAWINGS

FIG. 1 is a schematic representation of an example system for hardware management according to one or more embodiments.

FIG. 2 is a schematic representation of an example computing device for hardware management in accordance with one or more example embodiments.

FIG. 3 is a diagram of an example system for hardware management in accordance with one or more example embodiments.

FIG. 4 is a representation of a hardware management system in accordance with one or more example embodiments.

FIG. 5 is a representation of a hardware management system having a verification framework in accordance with one or more example embodiments.

FIG. 6 is a representation of a hardware management system having a verification framework in accordance with one or more example embodiments.

FIG. 7 is a flow diagram of a method to validate content out-of-band in accordance with one or more example embodiments.

FIG. 8 is an example computing device with a hardware processor and accessible machine-readable instructions in accordance with one or more example embodiments.

### DETAILED DESCRIPTION

One or more examples are described in detail with reference to the accompanying figures. For consistency, like elements in the various figures are denoted by like reference numerals. In the following detailed description, specific details are set forth in order to provide a thorough understanding of the subject matter claimed below. In other instances, well-known features to one of ordinary skill in the art having the benefit of this disclosure are not described to avoid obscuring the description of the claimed subject matter.

Increasingly complex computer infrastructure is commonly used to perform computing tasks. Data centers are often used to host this computing infrastructure. Such data centers may include various electronic devices that make up the computing infrastructure. Examples of electronic devices include compute platforms, such as servers, that may be used to process data. During the lifespan of computing systems, the computing systems may be affected by various internal or external security breaches. For example, compute platforms may be affected by malicious software, such as viruses, spyware, worms, and the like.

To prevent malicious software from affecting a computing system, security tools are used to both prevent the installation of malicious software, as well as to remediate a system that is infected. Such security tools or security applications are run within the computing environment and thus affect the performance of the system. For example, running a security tool in the computing environment may decrease system performance due to the local resources required to run the security tool. Additionally, should a computing system be infected with malicious software, the security tool may use valuable system resources in an attempt to remediate the condition. The infected state of the computing system may impede security tool operation. Remediation is tool specific and cannot necessarily return an operating system and/or application environment to a prior, known good state.

Furthermore, security tools require maintenance on a per compute system basis, thereby requiring ongoing updates that may require performance interruptions. For example, in order to update certain security tools, a computing system may require a re-boot, which takes the system offline, thereby decreasing performance and disrupting workloads.

Running such security tools within the computing system environment is referred to as in-band because the management of the application is performed within the computing environment. Out-of-band management refers to management that is performed external to the computing environment and may include use of dedicated channels for managing devices as well as devices and applications external to the computing system. In certain examples, a baseboard management controller (“BMC”) may be used to implement out-of-band management. A BMC may include a specialized microcontroller that is embedded on the motherboard of a computing device, such as a server. The BMC may thus monitor the physical state of a compute device. Such out-of-band management may conserve system resources by performing specific tasks outside of the computing system environment. By removing workload detrimental tasks out-of-band, increased system performance may be realized.

Implementations of the present disclosure may provide methods and systems for moving network security applications out-of-band. Such out-of-band solutions may allow a computing environment to continue operating without experiencing the workload detrimental effects of in-band security tools. Additionally, out-of-band solutions may allow remediation that does not affect computing system performance. For example, an operating system or application may become infected with malicious software. Rather than run resource intensive remediation tools, the operating system or application may be replaced with a version of an operation system or application in a known good state. Because the operating system or application is in a known good state, the computing environment will be verifiably remediated, rather than relying on remediation tools that may or may not return the computing environment to a known good state. Additionally, analysis may be performed out-of-band, thereby preventing malicious software from fooling analysis tools.

To validate content in a computing environment out-of-band, systems and methods disclosed herein identify content, such as an operating system, an application stack, and the like, that is being prepared for deployment. The content is measured through analyzation to establish a content baseline. The content baseline refers to the known state of the content prior to deployment, and thus prior to potential exposure and susceptibility to malicious software. Once the content is deployed, the deployed content may be copied. When the content requires validation, exposure to malicious software is suspected, system performance is not as expected, or for various other reasons the content requires analysis, the copied deployed content may be compared with the content baseline.

While the copied deployed content is compared to the content baseline, the content is still actively deployed on the computing system. In certain implementations, the content may be actively provided or running, while in other implementations, the content may be actively deployed, but not currently in use. As such, performance of the system is not affected by the analysis. During the analysis, a difference may be identified between the copied deployed content and the content baseline. Identification of this difference may thereby allow remediation steps to be taken. For example, remediation may include running one or more remediation tools, replacing the content with content in a known good state, building new content, shutting down the deployed active content, or otherwise taking actions to correct an identified difference. In certain implementations the difference between the copied deployed content and the content baseline may not require remediation, at which point the active content may be verified as being in a good state.

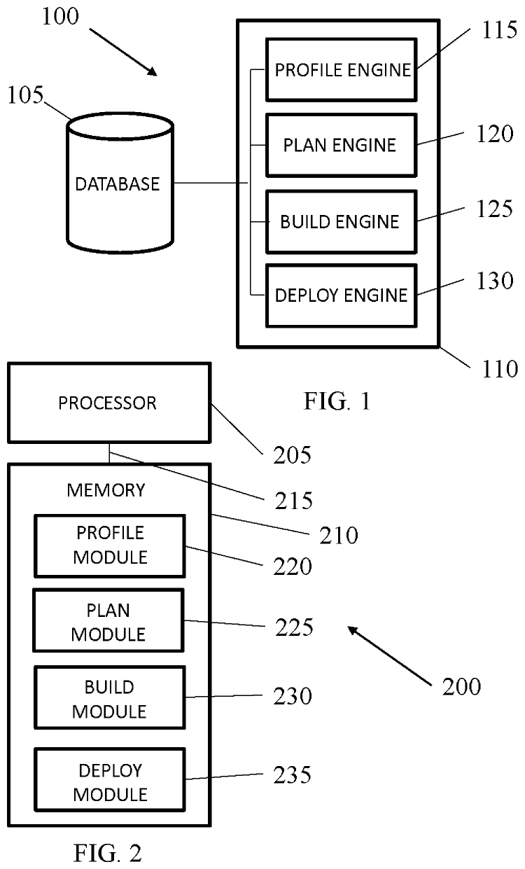

Turning to FIG. 1, a schematic representation of an example system for hardware management according to one or more embodiments is shown. FIG. 1 shows a system 100 that includes a database 105, and a hardware management system 110. Hardware management system 110, which may include management of virtual machines and software as well as physical computing resources, includes a number of engines, such as profile engine 115, plan engine 120, build engine 125, and deployment engine 130. Hardware management system 110 may communicate with database 105 through various wired or wireless connections. While hardware management system 110 is illustrated as including four engines, in other implementations a fewer or greater number of engines may be included that are capable of performing functions that will be described in detail below.

The set of engines, i.e., profile engine 115, plan engine 120, build engine 125, and deployment engine 130 can include a combination of hardware and programming that are configured to perform specific functions. Examples of functions that the set of engines may perform include generating a profile including a deployment plan for a computing device and generating a master volume based on the deployment plan, the master volume being stored in a volume storage. Other functions may include generating a copy of the master volume and providing a set of scripts to alter the copy of the master volume based on the deployment plan. Additional functions may include deploying the altered copy of the master volume to a computing device.

Profile engine 115 may include hardware and/or programming in order to generate a profile including a deployment plan to a computing device. Generating a profile may include a selection of a set of configuration features for the computing device. In certain implementations profile 115 engine may make configuration changes to the computing device based on the profile. In certain implementations, the profile may be used to select or generate a corresponding deployment plan for generating an instruction volume that may be deployed to a computing device. The instruction volume may include boot instructions or run instructions that may be used to configure the computing device, operating system, and/or applications.

Plan engine 120 may include hardware and/or programming in order to generate a master volume based on the deployment plan. In certain examples, generating the master volume may include copying a golden image, e.g., a master image, a cache image, or any type of storable content, of a computing device. The golden image may include a set of default configuration settings and custom settings based on the deployment plan or generated profile. In certain implementations, the golden image may include a copy of a volume that was previously used by a computing device, while in other implementations the golden image may include an archive of files or instruction packages, such as software packages.

A volume is a logical disk format that may be used in specific implementations. However, the approach may be generalized to include a content format that is able to support replication, such as formats and implementations supporting fast replication. For example, shared memory technologies using virtual memory access may be used. In such an approach, virtual memory architecture may provide a hierarchy of pointers that is able to quickly replicate content to different logical copies with separate access.

The build engine 125 may include hardware and/or programming in order to generate a copy of the master volume and to provide a set of scripts to alter the copy of the master volume based on the deployment plan. The altered copy may include an operating system boot volume. In certain implementations the altered copy may include an operating system boot volume altered for used by a computing device, and in some implementations the altered copy may include secret or security content. Generating a copy of the master volume may include copying a set of settings to a second volume such as an instruction volume. The instruction volume may be customized to include a set of altered settings. In certain implementations the set of settings may be altered through a set of executable scripts.

The set of executable scripts may be applied to the instruction volume based on a set of configuration selections. The configuration selections may be provided to a user through a user interface and/or computer program interface. The configuration selections may be based on a computing device type where the instruction volume is to be deployed. The configuration selections may further be based on a profile of the user. For example, a set of configuration selections may be presented to a user via a user interface to enable a user to select an option for each of the set of configuration selections.

The deployment engine 130 may include hardware and/or programming in order to deploy the altered copy of the master volume to a computing device. Deploying the altered copy of the master volume may include deploying an instruction volume that includes a set of customized configuration selections. In some examples, deploying an instruction volume may include a boot volume and firmware configuration for the computing device. The boot volume and firmware configuration may be implemented by the build engine 125 via a set of scripts that alter the instruction volume.

In some examples, a BMC may be used to implement services for a computing device. The BMC may be implemented using a separate processor from the processor that is used to execute a high-level operating system. BMCs can provide so-called “lights-out” functionality for computing devices. The lights out functionality may allow a user, such as a systems administrator, to perform management operations on a computing device even if an operating system is not installed or not functional on the computing device. Moreover, in one example, the BMC may run on auxiliary power, thus the computing device need not be powered on to an on state where control of the computing device is handed over to an operating system after boot. As examples, the BMC may provide so-called “out-of-band” services, such as remote console access, remote reboot and power management functionality, monitoring health of the system, access to system logs, and the like.

As noted, in some instances, a BMC may enable lights-out management of computing device that provide remote management access (e.g., system console access) regardless of whether the computing device is powered on, whether a primary network subsystem hardware is functioning, or whether an operating system is operating or even installed. A BMC may include an interface, such as a network interface, and/or serial interface that an administrator may use to remotely communicate with the BMC. In some examples, the BMC may be included on a system board of a server, in other examples a management controller can be included at another location, for example, a blade chassis to support multiple blade devices.

Turning to FIG. 2, a schematic representation of an example computing system for hardware management according to one or more embodiments is shown. The computing device 200 may use software, hardware, firmware, or logic to perform functions described herein.

Computing device 200 may include hardware and/or programming instructions configured to share information. The hardware, for example, may include one or more processors 205 or memory 210 (e.g., computer-readable medium (CRM), machine readable medium (MRM), database, etc.). Processors 205 may include any set of processors capable of executing instructions stored by a memory 210. Processors 205 may be implemented in a single device or distributed across multiple devices. The program instructions (e.g., computer readable instructions (CRI)) may include instructions stored on the memory 210 and executable by the processors 205 to implement a desired function (e.g., generate an instruction volume by copying a master volume, wherein the instruction volume is a computing device image, execute a set of scripts to alter the instruction volume based on a profile for a computing device, deploy the instruction volume to the computing device to configure the computing device based on the profile for the computing device, etc.).

Memory 210 may be in communication with a processors 205. Memory 210 may include any set of memory components capable of storing instructions that can be executed by processor 205. Memory 210 may be a non-transitory computer-readable media (“CRM”) or machine-readable media (“MRM”). Memory 210 may also be integrated in a single device or distributed across multiple devices. Further, memory 210 may be fully or partially integrated in the same apparatus as processor 205 or it may be separate but accessible to that a and processor 205. Computing device 200 may be implemented on a participant device, on a server device, on a collection of server devices, or a combination of the participant device and the server device.

Memory 210 may be in communication with processor 205 via a communication link (e.g., a path) 215. Communication link 215 may be local or remote to a machine (e.g., a computing device) associated with processor 205. Examples of a local communication link 215 may include an electronic bus internal to a machine (e.g., a computing device) where the memory 210 is one of volatile, non-volatile, fixed, or removable storage medium in communication with the processor 205 via the electronic bus.

A set of modules (e.g., profile module 220, plan module 225, build module 230, and deployment module 235) may include CRI that when executed by the processor 205 can perform functions. The set of modules (e.g., profile module 220, plan module 225, build module 230, and deployment module 235) may be sub-modules of other modules. For example, the profile module 220 and the plan module 225 may be sub-modules or contained within the same computing device. In another example, the set of modules (e.g., profile module 220, plan module 225, build module 230, and deployment module 235) may include individual modules at separate and distinct locations (e.g., CRM, etc.).

Each of the set of modules may include instructions that when executed by processor 205 may function as a corresponding engine as described herein. For example, the profile module 220 may include instructions that when executed by processor 205 may function as the profile engine 115 of FIG. 1.

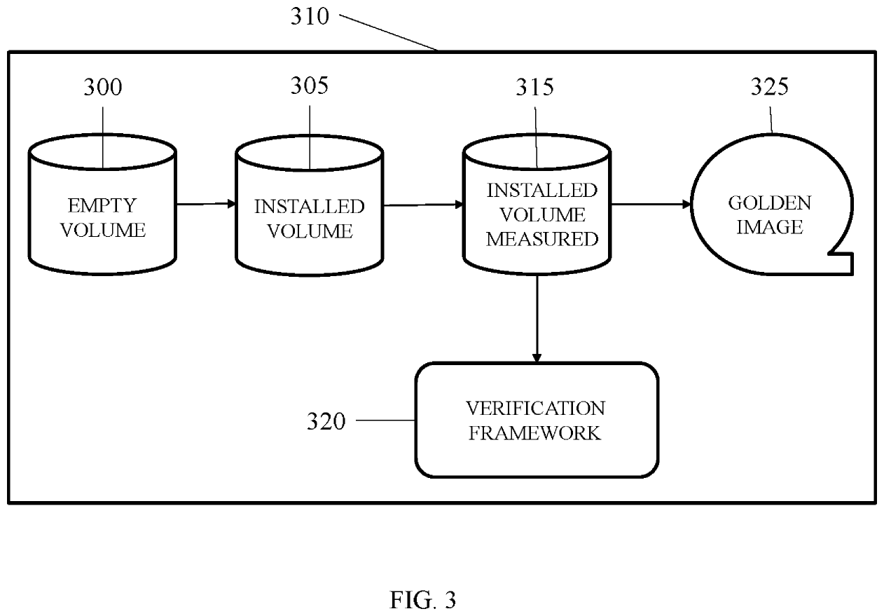

Turning to FIG. 3, a schematic representation of capturing an image with verification measurements according to one or more example embodiments is shown. In certain implementations an empty volume 300 may be deployed within a hardware management system 310. Empty volume 300 may be capable of receiving content provided by a user. Examples of content may include operating systems, applications, application stacks, media, or any other type of data capable of being stored thereon.

A user may then install the desired content creating an installed volume 305 within hardware management system 310. The user may then identify certain portions of the content to measure 315. Measuring refers to generating reference measurements that includes specific information contained in the content that a user may use to check the status of the content or specific aspects of the content. For example, the user may identify binary, script, config files, log files, directory listing, etc. for which the user would later be able to check in order to validate functionality of the content. In certain implementations, the user may specify that the entire content should be measured 315, while in other implementations the user may only specify a portion of the content to be measured 315. The user may indicate the content to be measured directly through use of a user interface. Additionally, the content to be measured may be indicated by previously specified details or by eternally provided details that the user references.

After the user identifies the content to measure 315, the measurements are created and loaded into a verification framework database 320. The verification framework 320 database may store the measurements until a user determines that validation of the content should be performed, at which time the verification framework database 320 may use or otherwise make the measurements available for hardware management system 310 to use in validating specified content. Verification framework database 320 may include several different functionalities. Verification framework database 320 may include a provisioning stage that provides a cryptographic identity to a platform with the assurance that it cannot be tampered with or impersonated. Verification framework database 320 may further include a registration state (not shown), which is a one-off operation used to register a platform with the verification framework 320 appliance. Verification framework database 320 may also include an attestation stage (not shown), which is the continuous operational process of the framework that periodically verifies the state of each platform registered in the appliance. Furthermore, verification framework database 320 may be loaded to indicate that incoming content is acceptable. For example, verification framework database 320 may be loaded in anticipation of content that is replicated between multiple sites as a way of assuring that remediation has been achieved correctly and content has not otherwise been exposed to malicious software.

Before or while the content is measured 315, a golden image 325 of the installed volume 305 is captured. The golden image 325 is a duplicate of the content on a specific installed volume 305. The golden image 325 is stored in hardware management system 110 and provides a known image of the content at the time the content was captured. As such, hardware management system 110 has an image of the content that is known to be operating with a good state, thereby providing a known baseline for the content. Because the content was measured 315 when the content was within the good state, the measurements may later be used to validate the state of the content.

After deployment of the content, a user may want to validate the state of the content to determine if it is functioning properly or otherwise to identify if the content is infected with malicious software. The hardware management system 310 may then take a copy of the deployed content and compare the deployed content with the measurements that were taken when the golden image 325 was created. Differences between the deployed content and the baseline content may be identified. Certain differences may be expected, while other differences may not be expected. In a situation where the differences are expected, no action may be required, and the copy of the deployed content may be deleted. In the event a difference is identified, the verification framework 320 may be used to determine what the difference is and whether specific action should be taken. For example, if the identified difference is not substantial and/or is not otherwise effecting system performance the identified difference may be ignored. However, in other examples, the identified difference may cause decreased system performance, provide a potential security risk, or otherwise result in a condition that is not desirable. In such a situation, different remedies may be available.

Examples of remedies may include shutting down operation of the computing system on which the content is disposed. The content may then be replaced with newly generated content based on the content saved as the golden image 325. For example, the golden image 325 may include a copy of an operating system. During validation of the operating system the hardware management system 310 may identify malicious software. The hardware management system 310 may inform a user that there is malicious software and the user may remove the installed operating system and replace the operating system with another operating system created from the golden image 340.

In other examples, the user may choose to remediate the issue using remediation tools. In such a situation, the remediation tools may be used on the copy of content when the content is not in use, thereby not wasting system resources. To remediate the issue, the copy of the deployed content may be remediated and upon completion, may be used to replace the deployed content that was still active as remediation occurred. In another example, the copy of the deployed content may be remediated and then the solution provided to the actively deployed content.

In still other examples, remediation may result in hardware management system 310 automatically shutting down the computing device containing the content. In such a situation, the computing device may be turned off or taken offline without user input. The user may then be informed of the decision and the user may choose the appropriate course of action. In an alternative implementation, a user may be alerted of the issue and the user may remove access to the content by taking the computing device offline.

In other examples, remediation may include providing a copy of identified errors to a third party. The third party may be a party specialized in certain types of remediation or may include interested users of the content. In this situation, the third party may decide on the type of appropriate remediation and either inform the user of how to proceed or otherwise provide instructions to hardware management system 310. Various other remediation solutions may be available depending on the specific situation. The remediation options identified above are illustrative of the types of solutions that may be available and are not intended as a limitation on the present disclosure. In still other examples, remediation may include providing in-band remediation after out-of-band analysis is performed. In such an example, a hardware management system may make changes to the deployed content with or without assistance of an operating system and/or application software of the computing device.

Because the analysis of the content, as well as potential remediation, occurs out-of-band, a computing system using the content is not affected. Said another way, the deployed content is copied, and the deployed content continues to be active. While the deployed content is active, on a different computing system, e.g., a system not using the same processing resources as the computing system using the deployed content, the copy of the deployed content is compared with the content baseline. Thus, the active content is continually used without the potential negative effects associated with verification and remediation tools used in-band.

Example hardware management systems 310 are discussed below that may be used in performing the validation and remediation of content disclosed herein.

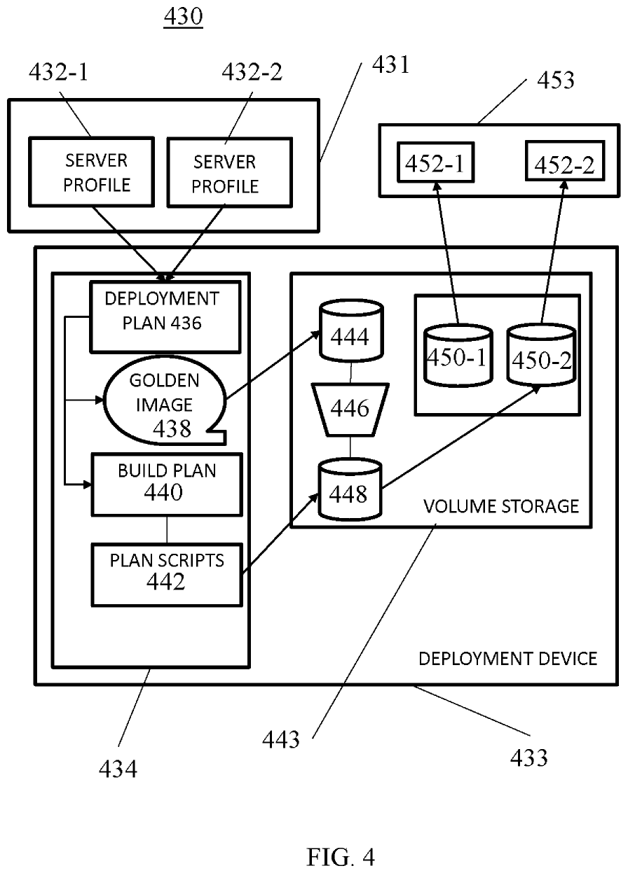

Referring to FIG. 4, a representation of a hardware management system according to one or more embodiments is shown. System 430 may include a profile manager 431 that is configured to receive, generate, or manage a set of server profiles 432-1, 432-2. The server profiles 432-1, 432-2 may be used to generate a set of instruction volumes 450-1, 450-2 that may be deployed to a set of computing devices 452-1, 452-2, which may be stored within a blade enclosure 453. Instruction volumes 450-1, 450-2 may include various content, such as operating system data, application data, media, and any other type of content that may be stored thereon. The profile manager 431 may be connected to a deployment device 433, which may include a repository 434 and a volume storage 443 for generating the set of instruction volumes 450-1, 450-2 to be deployed to the set of computing devices 452-1, 452-2. In certain implementations, volume storage 443 may be an external storage volume that may be temporarily connected to system 430, thereby allowing content to be stored externally.

The profile manager 431 may be used to generate server profiles 432-1, 432-2 and/or may be used to provide a set of configuration selections for generating server profiles 432-1, 432-2. Such configuration selections may be used to customize hardware settings such as boot settings or run settings for computing devices 452-1, 452-2. In some examples, profile manager 431 may store several profiles 432-1, 432-2 such that the server profiles 432-1, 432-2 may be accessed at a later time to enable additional execution of the server profiles 432-1, 432-2 after use of computing devices 452-1, 452-2 or after use of computing devices other than computing devices 452-1, 452-2.

Repository 434 may include a deployment plan 436 that may be based on a corresponding server profile 432-1, 432-2. Deployment plan 436 may define a set of execution steps for deploying a specific instruction volume 450-1, 450-2 to a specific computing device 452-1, 452-2. Deployment plan 436 may further define an execution of server profiles 432-1, 432-2 to generate corresponding instruction volumes 450-1, 450-2 stored in volume storage 443. In certain implementations, deployment plan 436 may define a set of parameters within a build plan 440 that may be used to define a set of plan scripts 442.

In some examples, server profiles 432-1, 432-2 may be used to select a golden image 438. Golden image 438 may be a master of a computing device 452-1, 452-2. For example, golden image 438 may be a master image that includes operating system configuration data, applications, and the like. In certain instances, golden image 438 may include an image generated from a computing device 452-1, 452-2 when the computing device was operating at a particular specification.

In some examples, the golden image 438 may be copied and stored in the volume storage 443 as a golden volume 444. Golden image 438 is stored in repository 434, thereby providing a base image from which golden volume 444 is created. In some examples, golden volume 444 may be a volume that is not altered. As such, golden volume 444 may provide a base volume from which clone volumes, such as instruction volume 448, may later be created. Golden volume 444 may be used for numerous different server profiles 432-1, 432-2. For example, golden volume 444 may be used to generate a specific instruction volume 450-1 from a selected server profile 432-1 and the golden volume 444 may be used to generate another instruction volume 450-2 from a different selected server profile 432-2. In some examples, different server profiles 432-1, 432-2 can use different golden images 438 and different golden volumes 444 for generating a particular instruction volume 450.

In some examples, the golden volume 444 may be copied to an instruction volume 448. In some examples, a smart clone engine 446 may be used to copy the golden volume 444 and generate the instruction volume 448. In some examples, the smart clone engine 446 may be used to copy configuration settings from golden volume 444 to generate instruction volume 448. In some examples, smart clone engine 446 can copy configuration settings from golden volume 444 based on a corresponding server profile 432-1, 432-2. Smart clone engine 446 may be considered a smart engine because it may be used to create instruction volumes, such as instruction volume 448, which is a fully featured, writable volume, nearly instantaneously. In specific implementations, smart clone engine 446 may use a copy-on-write design to copy golden volume 444 to an instruction volume 448, thereby allowing information to be duplicated and subsequently stored quickly.

In some examples, the deployment plan 436 may define a build plan 440. The build plan 440 may be used to generate plan scripts 442 for altering the instruction volume 448. As described herein, build plan 440 may be based on a corresponding server profile 432-1, 432-2. For example, a set of configuration settings can be selected for server profile 432-2 and build plan 340 may define plan scripts 442 for altering instruction volume 448 to reflect the set of configuration settings. In some examples, plan scripts 442 may be transferred to instruction volume 448 to alter instruction volume 448. That is, plan scripts 442 may include a set of scripts, e.g., instructions, etc. that may be used to customize instruction volume 448 based on a corresponding server profile 432-1, 432-2.

When the plan scripts 442 are implemented in instruction volume 448, the instruction volume 448 may be stored within volume storage 443 as instruction volume 450-2. The deployment device 433 may allow the plan scripts 442 to run within the repository 434, e.g., build environment, etc. In some examples, the deployment device 433 can allow read-only access to particular instruction volumes and allow read/write access to other instruction volumes. In some examples, the plan scripts 442 can be provided to alter the instruction volume 448 offline from the computing devices 452-1, 452-2. That is, the plan scripts 442 may not be executed on the computing devices 452-1, 452-2 until the plan scripts 442 have been provided to the instruction volume 448 and the instruction volume 448 has been transferred to volume storage 443 as instruction volume 450-2.

In some examples, a set of containers or virtual machines may be used to provide a repository 434 to transfer the plan scripts 442 to the instruction volume 448. Using the set of containers or virtual machines can protect the deployment device 433 from malicious scripts that may be embedded in the plan scripts 442. The set of containers or virtual machines may be used to generate a build environment as described herein. In addition, the set of containers or virtual machines may allow the deployment device 433 to reuse instruction volumes 450-1, 450-2 for deployment or allow the deployment device 433 to dispose of instruction volumes 450-1, 450-2 and generate new instruction volumes.

In some examples, a set of containers or virtual machines may be used to provide a repository 434 to transfer the plan scripts 442 to the instruction volume 448. Using the set of containers or virtual machines can protect the deployment device 433 from malicious scripts that are embedded in the plan scripts 442. The set of container or virtual machines may also be used to generate a build environment as described herein. In addition, the set of containers or virtual machines can allow the deployment device 433 to reuse instruction volumes 450-1, 450-2 for deployment or allow the deployment device 433 to dispose of instruction volumes 450-1, 450-2 and generate new instruction volumes.

In some examples, the build plan 440 can define a set of security settings for a computing device 452-1, 452-2. For example, the build plan 440 can define a type of security platform to be implemented on the computing device 452-1, 452-2. In some examples, the type of computing device may be used to determine the type of security platform to be implemented.

In some examples, the instruction volumes 450-1, 450-2 can be deployed to a set of computing devices 452-1, 452-2. In some examples, the instruction volumes 450-1, 450-2 can be a set of different instruction volume versions for a set of different computing devices 452-1, 452-2. For example, a server manager can deploy instruction volume 450-1 to computing device 452-1 for a first period of time and deploy instruction volume 450-2 to computing device 452-1 for a second period of time. In another example, a server manager can deploy instruction volume 450-1 to computing device 452-1 when utilizing the computing device 452-1 for a first functionality and deploy instruction volume 450-2 to computing device 452-1 when utilizing the computing device 452-1 for a second functionality. In some examples, the first functionality and the second functionality can utilize a set of different applications, virtual machines, or configuration settings to execute a corresponding set of functions.

In some examples, the instruction volumes 450-1, 450-2 can be deployed to the set of computing devices 452-1, 452-2 via image-based deployment. As used herein, image-based deployment can include applying the instruction volumes 450-1, 450-2 as golden image structures. That is, the instruction volumes 450-1, 450-2 can be deployed and applied to the computing devices 452-1, 452-2 as if the instruction volumes 450-1, 450-2 were a golden image 438. In some examples, the image-based deployment of the instruction volumes 450-1, 450-2 can allow the computing devices 452-1, 452-2 to be booted directly based on the deployed instruction volumes 450-1, 450-2. 1

In some examples, the instruction volumes 450-1, 450-2 can include hardware configurations and instruction configurations for a corresponding computing device 452-1, 452-2. For example, a set of hardware settings can be defined by the instruction volumes 450-1, 450-2 and a set of software settings can be defined by the instruction volumes 450-1, 450-2. In some examples, deploying the instruction volumes 450-1, 450-2 can include simultaneously configuring the hardware and software of the computing devices 452-1, 452-2. In some examples, the configuration of the computing devices 452-1, 452-2 can be performed with less time compared to previous systems and methods.

In some examples the instruction volumes 450-1, 450-2 stored within the volume storage 443 can be examined for malicious software and other malicious instructions prior to being deployed to the set of computing devices 452-1, 452-2. As described herein, the plan scripts 442 can include malicious scripts that can negatively affect the instruction volumes 450-1, 450-2. In previous systems, the malicious scripts could potentially affect the OS of the computing devices 452-1, 452-2. However, by examining the instruction volumes 450-1, 450-2 for malicious software prior to deploying the instruction volumes 450-1, 450-2 can prevent the malicious scripts from affecting the operating system of the computing devices 452-1, 452-2.

In some examples, a set of actions can be executed by separate components discussed in detail below upon detection of malware. In some examples, the set of actions can include, but are not limited to: making a copy of the instruction volumes 450-1, 450-2; disabling access to the instruction volumes 450-1, 450-2; stopping a computing device 452-1, 452-2 that is utilizing the instruction volumes 450-1, 450-2; reapplying a profile to repair the computing device; redeploying the instruction volumes 450-1, 450-2; or changing the content of instructions volumes 450-1, 452-2 with or without assistance of the operating system and the application software thereof.

The system 430 can enable for hardware management that is easier to execute and manage hardware by providing enhanced features of the instruction volumes 450-1, 450-2 compared to previous systems and methods. The system 430 can provide a visual and programmable representation of instruction volumes 450-1, 450-2 that can be deployed to configure and boot a particular computing device 452-1, 452-2. The system 430 can be utilized to simultaneously configure hardware and instructions corresponding to the computing devices 452-1, 452-2. By configuring the hardware and instructions simultaneously, the hardware and instruction configurations can maintain consistency and provide better computing device performance.

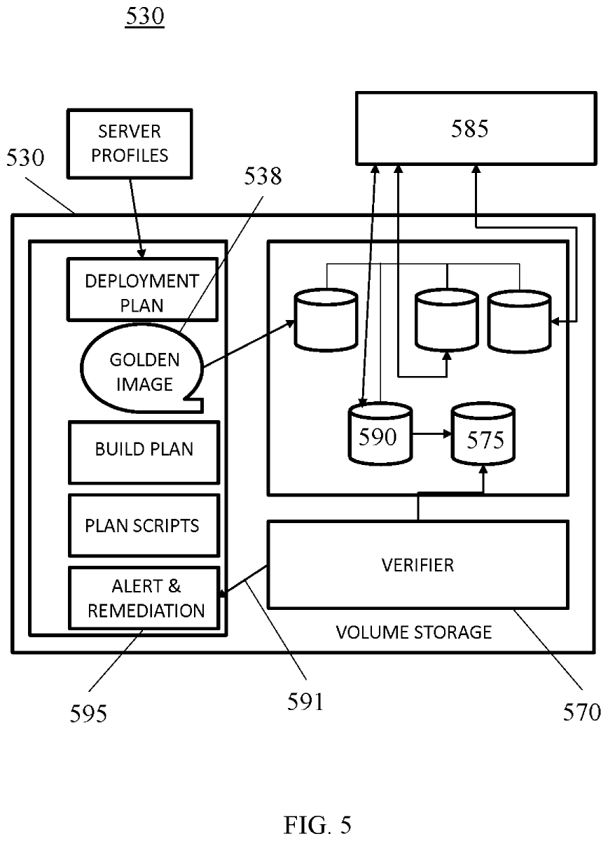

Turning to FIG. 5, a representation of a hardware management system having a verification framework according to one or more embodiments is shown. System 500 includes many of the same components discussed above with respect to FIG. 4. As such, for brevity and clarity in understanding the present disclosure, a detailed description of like components is not provided herewith. Additionally, certain reference characters are excluded for clarity. FIG. 4 provided for a system that is capable of making copies of instruction volumes from a golden image and deploying the copies to various computing devices. Such systems allow for the rapid transferability of data from deployment devices to computing devices. However, as discussed above, during operation, content on computing devices may become infected with malicious software, may not be performing as expected, or may be experiencing other issues effecting performance.

System 530 includes content that may include instruction content, as explained above with respect to FIG. 4. Content may further include any type of deployable or storable information, such as operating system data, application data, media, and the like.

In order to verify that content on a computing device is operating as intended, examples provided with respect to FIG. 5 provide a hardware management system 530 including a verifier 570. Verifier 570 may include hardware and/or programming in order to determine whether specific content is not functioning as intended. For example, verifier 570 may include functionality to determine whether the content has been exposed to or is otherwise being affected by malicious software. Additionally, verifier 570 may include functionality to determine whether the computing device is not operating as intended. For example, log files may indicate that a user has inappropriate access to the content or has gained elevated computing privileges, that changes have been made that were not expected, or that other incorrect conditions exist within content, such as application or operating system software is not operating as intended or that the computing device is the subject of a network attack. Additionally, verifier 570 may include one or more engines, such as the engines and modules discussed above with respect to FIG. 1 and may be connected to a database. Additionally, verifier 570 may include memory and processors along with modules, such as those discussed above with respect to FIG. 2.

In certain implementations, rules may be applied by verifier 570 to determine whether content is wanted and/or unwanted. For example, a rule may be applied that verifies the form for specific content. In such an example, a software install log may be examined to verify that wanted software, such as a patch, has been installed. In another example, content may be examined to determine whether specific software known to contain problems is not installed. In such implementations, the software that defines the content may be examined to determine if specific rules are met. For example, content may be examined to determine if a specific file exists, if the content is correct per the recognized content patterns, or to determine if the content includes blocked with specified defined hash values. Accordingly, rules and/or scripts may be used to verify the content of a specific volume through use of verifier 570.

Verifier 570 is able to detect whether changes have been made to the content as a result of being provided the reference measurements, explained above, that define the content baseline. In operation, when the golden image 538 was originally captured, the reference measurements were taken, which established the content baseline. The reference measurements were then provided to verifier 570, so that during operation, should a user request validation or a validation be performed as a scheduled event, the deployed content may be verified.

Verifier 570 may automatically check content or users may provide specific instructions to verifier 570. For example, a user may conduct a search for specific issues within the content. Alternatively, the hardware management system 530 may be provided instructions to automatically validate content at specific instances. For example, hardware management system 530 may be programmed to validate content on a time-based routine, e.g., once a day, once a week, once a month, etc. In other implementations, management system 530 may be provided instructions to automatically validate content in response to events such as a computing device reboot, computing device configuration changes, write operations to the instruction volume, or other events specific to the computing device.

In order to validate content out-of-band, hardware management system 530 copies content, which is deployed, from a computing device, such as computing device 585 to create a content copy 590 in hardware management system 530. The content copy 590 is then cloned to create a deployed content copy 575. Verifier 570, which has access to the reference measurements, and thus has a baseline content, can compare aspects of the deployed content copy 575 against the baseline content. Because the baseline content and the reference measurements were taken from the golden image 538, any differences between the deployed content copy 575 and the baseline content indicate a modification that was made to the content after it was deployed.

If no differences are detected, verifier 570 may indicate to hardware management system 530 that no remediation is needed. Upon receipt of such notice, hardware management system 530 can delete content copy 590 and deployed content copy 575.

If verifier 570 identifies a difference between the deployed content copy 575 and the baseline content, verifier 570 may send notification/attestation 591 to hardware management system 530, such as to an alert and remediation engine 595. Alert and remediation engine 595 may include hardware and/or programming in order to alert a user or other device that a difference has been identified. In certain examples, alert and remediation engine 595 may also include tools that allow for the content to be remediated, as discussed in detail above. Additionally, remediation engine 595 may include one or more engines, such as the engines and modules discussed above with respect to FIG. 1 and may be connected to a database. Additionally, remediation engine 595 may include memory and processors along with modules, such as those discussed above with respect to FIG. 2.

In either instance, the process of identifying and verifying the status of the deployed content may occur out-of-band. Because hardware management system 530 takes a copy of the deployed content and performs the identification on the copy, not on the actual deployed content. As such, computing device 585 does not experience any change to performance, as may occur with in-band verification and remediations tools.

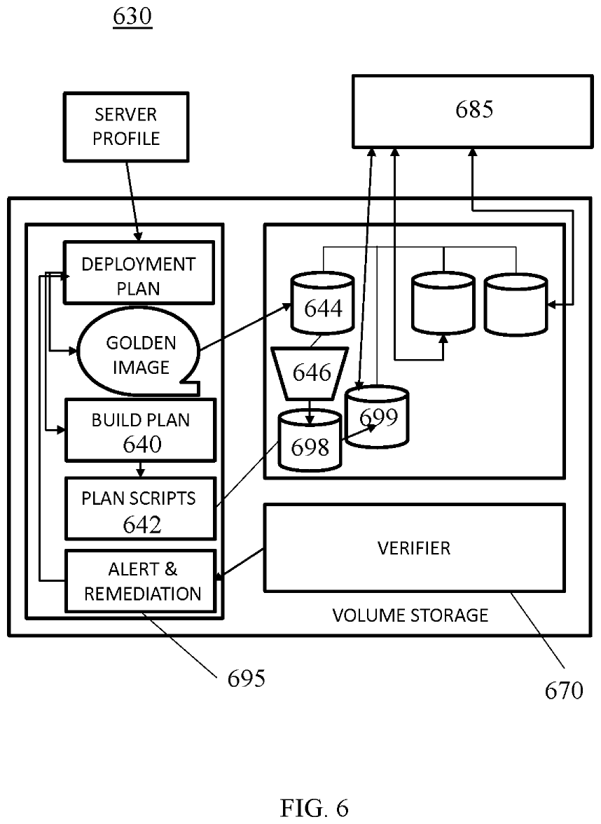

In certain implementations, in addition to alerting a user about a potential difference in the content, it may be beneficial to provide remediation that, either manually or automatically, is performed at least in part by hardware management system 530. Such implementations are discussed below with respect to FIG. 6.

Turning to FIG. 6, a representation of a hardware management system having a verification framework according to one or more embodiments is shown. System 600 includes many of the same components discussed above with respect to FIGS. 4 and 5. As such, for brevity and clarity in understanding the present disclosure, a detailed description of like components is not provided herewith. Additionally, certain reference characters are excluded for clarity. FIG. 6 shows a remediation option if a difference was detected that required replacement of the content.

After being alerted that the content was different by the verifier 670, the alerting and remediation engine 695 may indicate that the content should be redeployed. In operation, the redeployment of the content may include total redeployment, such as replacing an operating system, applications, or other data to be loaded into computing device 685. After notification is sent, smart clone engine 646 may receive instructions to create new content, such as to create a clone of an operating system from golden volume 644. Deployment device 636 may then provide a build plan 640 to provide plan scripts 642 that are provided to the replacement content 698.

Replacement content 698 may now include all necessary data to replace content presently deployed on computing device 685. Replacement content 698 may be loaded into storage 699 and sent back to computing device 685 to replace the active content.

The remediation illustrated in FIG. 6 is only one type of remediation. In other examples, only a part of the content may be replaced, additional content may be added and sent to replace the active content, content may be decreased, such as removing malicious software, computing device 685 may be shut down, rebooted, or otherwise modified. Additionally, users may be provided custom options in order to customize the way hardware management system 630 functions. For example, verifier 670 may allow a user to search or otherwise interact with content according to a set of user defined rules. The user may have the ability to look for certain files, file structure, data, data structure, data patterns, code, or other various options that may be beneficial in verifying the status of content on a computing device.

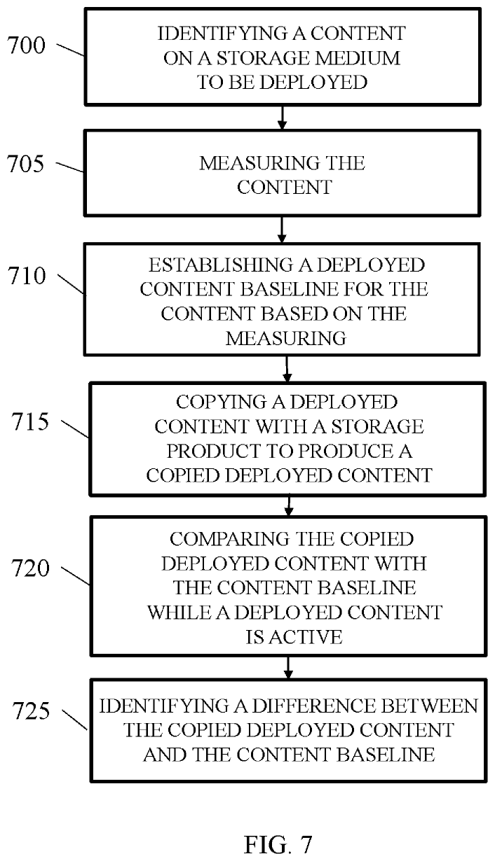

Turning to FIG. 7, a flow chart of an example method for validating content out-of-band according to one or more embodiments is shown. In this method, content is identified (700) on a storage medium that is going to be deployed. Content, such as operating systems, applications, software packages, or other types of data may be provided to an empty storage volume prior to being obtained as a golden volume so that the content may later be deployed. The content may be provided by one or more users and be accessible through a hardware management system, such as one or more of the hardware management systems described above.

The content may be measured (705) before or while a golden image is obtained. Measuring (705) the content may include generating reference measurements that include specific information contained in the content that a user may use to check the status of the content or specific aspects of the content. For example, the user may identify binary, script, config files, log files, directory listing, etc. for which the user would later be able to check in order to validate functionality of the content. In certain implementations, the user may specify that the entire content should be measured, while in other implementations the user may only specify a portion of the content to be measured.

The measured content may be provided to a verification framework and thereby establish (710) a deployed content baseline. The deployed content baseline refers to the content in a known state, and as such, users know how the content should function under the deployed content baseline condition.

A user may at some point request verification of the content. At this point, the deployed content may be copied (715) with a storage product to produce a copied deployed content. The storage product may include a storage medium, such as any type of storage device discussed above with respect to hardware management system. In operation, all or a portion of the content may be copied. Due to the implementation of the hardware management systems previously discussed, the copying aspect may occur in a matter of seconds.

After the deployed content is copied (715) the copied deployed content is compared (720) with the content baseline. During this comparison (720) the deployed content remains deployed. As such, the computing device running the content is not affected by the comparison (720). In certain implementations, one or more cloned copies of the content may also be made from the copied deployed content. As such, for purposes of this disclosure, the term copied deployed content may refer to either the copied deployed content or the clone of such content.

A difference between the copied deployed content and the content baseline may then be identified (725). The identification (725) may occur through a verifier or other types of verification framework, such as those discussed above. Identification (725) of a difference may include any difference in the content such as differences in the binary, script, config files, log files, directory listing, etc. Additionally, identifying (725) may include detecting any configuration change, detecting configuration changes that are expected, and detecting configuration changes that are not expected. In certain implementations, identification (725) may include determining access information for a deployed content. For example, the deployed content may have been accessed by users or third parties that should not have access to the deployed content.

If a difference is not identified (725), the copied deployed content may be deleted or saved for further use. If a difference is identified (725) a user, system, third party, etc., may be notified that a difference has been identified (725). After notification, remediation may occur. In certain implementations, remediation may occur without notification of a user. In such an implementation, the hardware management system may have instructions to take certain actions should a difference be identified (725). In one example, the difference between the copied deployed content and the content baseline may be remediated and provided to the deployed content. For example, malicious software may be removed from the deployed copy by remediating the copied deployed content and then sending the remediated content back to the computing system where the deployed content was running. In such an instance, the deployed content would be replaced with the remediated content.

In other implementations, remediating may include replacing the deployed content with a copy of the golden image, which may have been previously stored in the hardware management system. In still other implementations, the copied deployed content may be provided to a third party for remediation or may otherwise be remediated outside of the hardware management system. Specific remediation steps may depend on the differences that are identified (725). Regardless of the type of remediation that occurs, the actions taken may occur out-of-band, thereby not using computing system resources, not effecting the deployed copy, and allowing the content to be verified to the satisfaction of a user.

In other implementations, the verification framework database may further include expected deviations between the deployed content and a golden image. Thus, if the copied deployed content does not include the required specific deviations, remediations may be performed as explained above. Deviations may be added to the verification framework database through measured volumes or through other methods as required in specific implementations.

In certain implementations, identifying (725) a difference between the copied deployed content and the content baseline may include applying a rule, a script, and/or a set of rules and/or scripts. As such, content may be verified based on whether the content matches or does not match a specific rule. In such am implementation, the content may not require deployment and/or measurement (705). Rather, a verification framework may be used to verify the content of a specific volume through the rules and/or scripts. In operation, content may be captured and provided to the validation framework. The content may then be measured (705) using a pre-defined rule. In other implementations, the content may be measured (705) using a custom defined rule. For example, rules may be available or be customizable to identify specific information within the content, such as text, patterns of text, existence of wanted or unwanted content, missing wanted or unwanted content, and the like. In certain implementations, information within content to which specific rules may be applied may include text and binary formatted content and include content stored as files, file systems, other structured and raw or unstructured volume content, and the like.

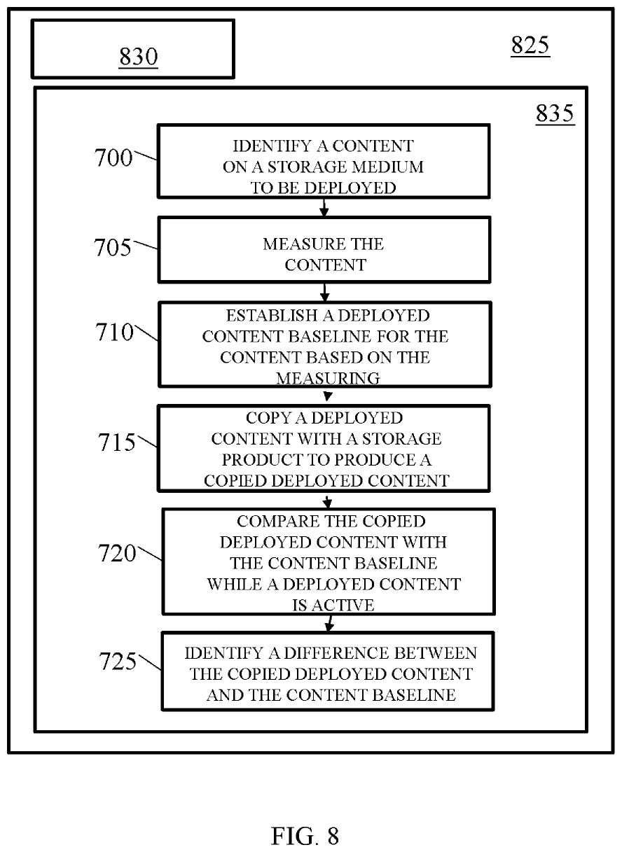

Turning to FIG. 8, an example computing device with a hardware processor and accessible machine-readable instructions according to one or more embodiments is shown. FIG. 8 provides an example computing device 825, with a hardware processor 830, and accessible machine-readable instructions stored on a machine-readable medium 835 for validating content out-of-band, as discussed above with respect to one or more disclosed example implementations. In certain implementations, a management controller, separate from the processor 830 of computing device 825, may include the non-transitory machine-readable storage medium 835 for validating content out-of-band. The management controller, such as a board management controller, explained in detail above, may be used to manage the interface between computing device 825 management software and hardware. In certain implementations, the management controller may be a hardware device or software program that manages or directs the flow of data between computing devices 825 and may include one or more processors (not independently shown) and/or external devices that allow for control of computing device 825.

FIG. 8 illustrates computing device 825 configured to perform the flow described in blocks 700, 705, 710, 715, 720, and 725, discussed in detail with respect to FIG. 7. However, computing device 525 may also be configured to perform the flow of other methods, techniques, functions, or processes described in this disclosure. For example, in certain implementations, blocks 700, 705, 710, and 715 may be excluded, thereby allowing a computing device to perform the flow illustrated in blocks 720 and 725.

A machine-readable storage medium, such as 835 of FIG. 8, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (“EPROM”), random access memory (“RAM”), non-volatile random access memory (“NVRAM”), optical disk, solid state drive (“SSD”), flash memory chips, and the like. The machine-readable storage medium may be a non-transitory storage medium, where the term “non-transitory” does not encompass transitory propagating signals.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

While the present teachings have been described in conjunction with various examples, it is not intended that the present teachings be limited to such examples. The above-described examples may be implemented in any of numerous ways.

Also, the technology described herein may be embodied as a method, of which at least one example has been provided. The acts performed as part of the method may be ordered in any suitable way. Accordingly, examples may be constructed in which acts are performed in an order different than illustrated, which may include performing some acts simultaneously, even though shown as sequential acts in illustrative examples.

Advantages of one or more example embodiments may include one or more of the following:

In one or more examples, systems and methods disclosed herein may be used to verify content on computing systems out-of-band, thereby preserving computing system resources.

In one or more examples, systems and methods disclosed herein may be used to remediate content on computing systems out-of-band, thereby preserving computing system resources.

In one or more examples, systems and methods disclosed herein may be used to analyze content on computing systems out-of-band, thereby preserving computing system resources.

In one or more examples, systems and methods disclosed herein may be used to validate content on computing systems out-of-band, thereby preserving computing system resources.

In one or more examples, systems and methods disclosed herein may be used to provide custom verification solutions to users to validate content on computing systems out-of-band.

In one or more examples, systems and methods disclosed herein may be used to automatically shut down computing systems that are determined not to be in a known good state.

In one or more examples, systems and methods disclosed herein may be used to quickly replace content, such as operating systems and applications in computing systems, thereby preventing computing downtime.

Not all embodiments will necessarily manifest all these advantages. To the extent that various embodiments may manifest one or more of these advantages, not all of them will do so to the same degree.

While the claimed subject matter has been described with respect to the above-noted embodiments, those skilled in the art, having the benefit of this disclosure, will recognize that other embodiments may be devised that are within the scope of claims below as illustrated by the example embodiments disclosed herein. Accordingly, the scope of the protection sought should be limited only by the appended claims.

What is claimed is:

1. A method of validating content out-of-band for a computing device having a processor capable of executing software with a management controller separate from the processor of the computing device, the method comprising:
identifying a content to be deployed, the content residing on a storage medium;
measuring the content;
establishing a content baseline for the content based on the measuring;
copying a deployed content to a storage product to produce a copied deployed content;
comparing the copied deployed content with the content baseline out-of-band while the deployed content is deployed; and
identifying a difference between the copied deployed content and the content baseline.

2. The method of claim 1, further comprising:
remediating a deployed content based on the difference between the copied deployed content and the content baseline.

3. The method of claim 2, wherein the remediating comprises automatically shutting down a computing system having the deployed content.

4. The method of claim 2, wherein the remediating comprises building a new content based on a golden image.

5. The method of claim 4, wherein the remediating comprises sending the new content based on the golden image to a computing system to replace the deployed content.

6. The method of claim 1, further comprising turning off a computing system having the deployed content based on the difference between the copied deployed content and the content baseline.

7. The method of claim 1, wherein the content comprises at least one of an operating system and an application.

8. The method of claim 1, further comprising analyzing the copied deployed content and determining access information for a deployed content.

9. The method of claim 1, wherein the identifying the difference comprises at least one of detecting configuration changes of the content, detecting configuration changes that are expected, and detecting configuration changes that are not expected.

10. The method of claim 1, further comprising alerting a user based on the difference between the copied deployed content and the content baseline.

11. The method of claim 1, further comprising deleting the copied deployed content while the deployed content remains deployed.

12. A system for out-of-band content validation, comprising:
a deployment device having, a volume storage, and a golden volume, wherein the deployment device is connected to a computing system having a deployed content;
a verifier connected to the deployment device, wherein the verifier has access to a copy of a deployed content in the volume storage and wherein the verifier compares the copy of the deployed content to a baseline and sends information about the comparison to the alert and remediation engine when in operation; and
an alert and remediation engine connected to the verifier to alert a user that the verifier identified a difference between the deployed content and the copy of the deployed content.

13. The system of claim 12, further comprising a smart clone connected to the golden volume.

14. The system of claim 12, further comprising a copy of the golden volume disposed in the volume storage.

15. The system of claim 12, wherein the verifier comprises a set of measurements representative of a baseline for the content.

16. The system of claim 12, wherein the golden volume comprises a copy of the deployed content in a known state.

17. A non-transitory machine-readable storage medium encoded with instructions for validating content out-of-band for a computing device having a processor and a management controller separate from the processor of the computing device, the management controller including the non-transitory machine-readable storage medium comprising instructions to:
copy a deployed content to a storage product to produce a copied deployed content;
compare the copied deployed content with the content baseline out-of-band while a deployed content is deployed; and
identify a difference between the copied deployed content and the content baseline.

18. The non-transitory machine-readable storage medium of claim 17, further comprising instructions to remediate the deployed content.

19. The non-transitory machine-readable storage medium of claim 17, wherein instructions to remediate comprises instructions to build a new content for deployment based on a golden image.

20. The non-transitory machine-readable storage medium of claim 17, wherein the instructions to identify a difference between the copied deployed content and the content baseline comprises instructions to apply a rule to the copied deployed content.
